(19) United States
(12) Patent Application Publication
(10) Pub. No.: US 2017/0350914 A1
(43) Pub. Date: Dec. 7, 2017

(54) SYSTEM AND METHOD FOR LONG-RANGE BALLISTIC CALCULATION

(71) Applicant: Kenneth L. Oehler, III, Austin, TX (US)

(72) Inventor: Kenneth L. Oehler, III, Austin, TX (US)

(21) Appl. No.: 15/610,847

(22) Filed: Jun. 1, 2017

Related U.S. Application Data
(60) Provisional application No. 62/344,467, filed on Jun. 2, 2016.

(51) Int. Cl. G01P 3/66

(52) U.S. Cl. CPC G01P 3/665

(57) ABSTRACT

A system for predicting exterior ballistics has first and second bullet detectors operable to detect the passage of a bullet, the first and second bullet detectors being spaced apart by a selected detector spacing distance, the first and second bullet detector each being connected to a common time signal facility that generates a time signal, the first bullet detector being operable to generate a first time of passage based on the time signal, the second bullet detector being operable to generate a second time of passage based on the time signal, the first bullet detector being operable to measure a first bullet velocity, a controller in communication with the first and second bullet detectors, and the controller operable based on the difference between the first time and the second time, and based on the first bullet velocity to calculate a ballistic characteristic for the bullet.

### CROSS-REFERENCE TO RELATED APPLICATION

This application claims the benefit of U.S. Provisional Patent Application No. 62/344,467 filed on Jun. 2, 2016, entitled “System and Method for Long-range Ballistic Calculation,” which is hereby incorporated by reference in its entirety for all that is taught and disclosed therein.

### FIELD OF THE INVENTION

The present invention relates to firearms, and more particularly to a system that measures initial velocity and time of flight of a bullet to a known distance, calculates a ballistic coefficient for the bullet, and enhances the ability of traditional predictive equations and procedures to accurately predict bullet paths for other distances and conditions.

### BACKGROUND OF THE INVENTION

Users of the science of external ballistics for small arms can be divided into two groups. Members of the first group (ballisticians, mathematicians, physicists, and engineers) are interested in the mathematical description of the behavior of the bullet in flight and the observation of this behavior during field tests. The second group (collectively known as shooters), care little about the theory or the testing required to validate a theoretical description. Shooters simply want to know what adjustments must be made in order to achieve a first-round hit on a distant target. It is the object of this invention to bridge the gap between the two groups.

The first group tends to think of the bullet as being right before their eyes. They visualize the force of gravity pulling the bullet down and the force of the aerodynamic drag slowing the speed of the bullet. Advanced models visualize the bullet rotating and include the inertial effects of the spinning mass of the bullet along with the aerodynamics of the tangential air flow. Some models may include the inclination of the bullets axis with respect to the flight path. Some models include earth-motion effects as the ground based reference points move in space. From the simplest model to the most complex, this first group visualizes bullet behavior as being governed by time. The second group thinks of bullet behavior simply as how far the bullet drops below the line of aim when it hits a target at long range or how far the shooter must aim above the target to achieve a hit.

The relationship between time and distance has always been essential. Evidently Newton's original postulation was that the drag force was simply proportional to the square of speed through the air. This allowed a precise relationship between time-of-flight and range. While Newton's solution may have been appropriate for slow moving bullets, it gave significant error as the speeds approached the “sound barrier” and traveled at supersonic speeds.

Ballisticians seek to improve their models. Shooters use the models and then provide feedback if the models show errors. The major correction to Newton's model is the addition of an empirical correction factor, typically called drag coefficient, to the original term describing the force generated by aerodynamic drag. This correction factor varies with velocity and a table of such correction factors is called the “drag function”.

In the last 150 years there has been effort to standardize the tables of drag coefficient versus velocity, but uncertainties remain. Each table is an approximation for a family of bullets having similar shapes; the table does not exactly represent any unique bullet. While bullets of similar shapes and function typically use the same drag function, individual bullets have a measured property called “ballistic coefficient”. The ballistic coefficient is defined as the ratio of the drag of the reference bullet to the drag of the specified bullet. Drag measurements are usually made near the muzzle with the bullet launched at “typical” velocities. Some bullet manufacturers improve the fit of their unique bullet to the drag table by providing “stepped ballistic coefficients” or different ballistics coefficients to be used for different velocity ranges. Other manufacturers use Doppler radar tests to provide unique drag functions for each of their bullets. Third parties may provide “custom drag functions” for the performance of bullets from different manufacturers.

The actual measurement of the drag of a specific bullet is difficult. The obvious best way is the use of Doppler radar where the Doppler frequency output is proportional to velocity. The change of this velocity with respect to time represents acceleration or drag. Alternatively, the deceleration of a bullet can be determined by the difference between a pair of velocity measurements. Because the velocities are large, and the velocity loss is small, small errors in velocity measurement are reflected as large relative errors in the observed velocity loss. Conventional practice for measuring ballistic coefficients is to measure velocity near the gun and the time-of-flight to a target typically located 100 to 300 yards from the gun. Data from this test over relatively short range can be expressed as a ballistic coefficient.

All these drag tables and ballistic coefficients share one common trait. They represent average performance as measured using only one or very few rifles. The data is often measured only at short ranges and at typical muzzle velocities. Data for lower velocities are often determined by “downloading” to obtain lower muzzle velocities from the same gun; such downloading does not reflect the stabilizing spin rates obtained through natural velocity decay. Firing “identical” bullets with different barrels will often lead to slightly different ballistic coefficients or even to different drag tables. The tables and ballistic coefficients may not represent the performance to be obtained with the user's unique rifle.

Present practice is marginally adequate for extreme long range predictions. Sport shooters have the advantage of shooting at discreet ranges and contest rules allow “sighting” shots prior to the recorded shots. The military sniper must determine the range with a rangefinder device (typically a laser device) and then accurately predict the “holdover” correction for his unique gun/ammo combination. Predictions must be highly accurate because no “sighter” shots are allowed.

The present best practice is for the shooter to “true” his individual gun/ammo combination at a long range by observing the actual bullet drop relative to the line-of-sight. This practice provides feedback to the shooter so that he can refine his prediction model to fit actual results. Note that actual bullet drop at the target must be measured or estimated. Few shooters can make accurate estimates of the drop at ranges beyond six or eight hundred yards. At longer ranges it is difficult to observe and estimate magnitude of bullet drop to the accuracy required for improved predictions. The old adage of “You can't predict what you can't measure!” becomes painfully true.

With modern instrumentation it has become apparent that even Doppler-radar-derived drag functions and “custom drag functions” must be trued by actual test firing in the user's gun to achieve the required accuracy at long range. While more advanced programs can correct for earth movement effects (Coriolis) and aerodynamic effects (spin drift and aerodynamic jump), they still rely on a drag table to accurately assign a given range to a given time-of-flight. Programs normally include provision to use an appropriate standard drag function, to use the stepped-ballistic-coefficient procedure, to adjust initial velocity, or even to adjust the “axial form factor” for a radar-derived drag function. Any of these ideas may be used to adjust the programs predicted output to match the firing observations.

### BRIEF DESCRIPTION OF THE DRAWINGS

FIG. 1 shows the shows the elementary relationship between distance and time.

FIG. 2 shows the distance-versus-time curves for three bullets.

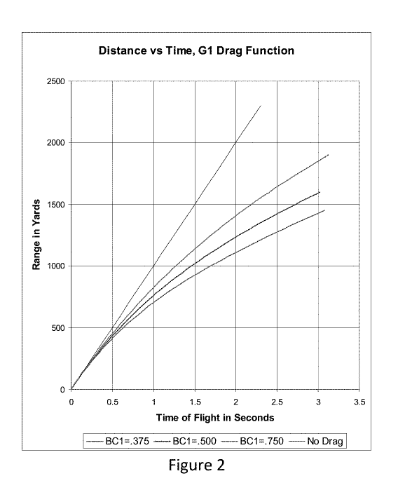

FIG. 3 shows similar curves using G7 predictions instead of G1 predictions.

FIG. 4 shows the G1 and G7 based predictions for drop and wind, which agree within 0.05 mils out to 1000 yards.

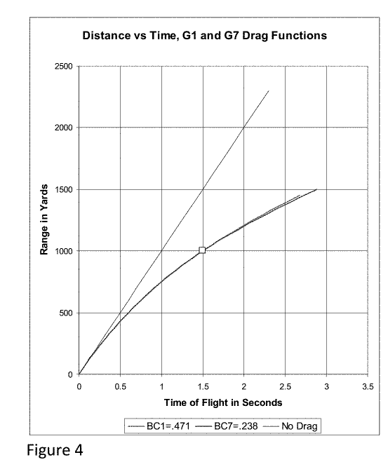

FIG. 5 shows the blue G1 curve is obscured by the red G7 curve out to approximately 1500 yards.

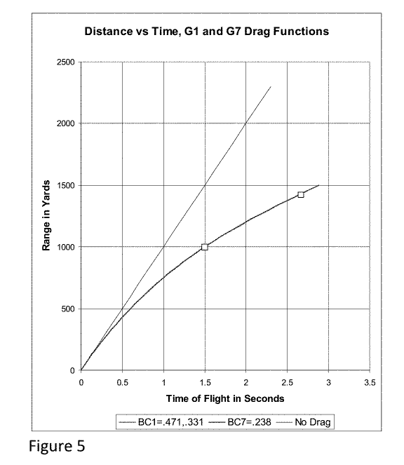

### DETAILED DESCRIPTION OF THE PREFERRED EMBODIMENT

For this discussion we assume that the initial velocity of the bullet can be accurately measured with a chronograph or other means and that the effects of the air density and the speed of sound in air are well known and accurately reflected in ballistic calculations.

The essential element of this invention requires an extension of the customary definition of ballistic coefficient. Ballistic coefficient is customarily defined as the drag of the theoretical projectile divided by the drag of the tested bullet at a specified velocity. When combined with the classical ballistic equations, this definition provides an accurate prediction of time-of-flight over the typical range (say 100 to 300 yards). We extend the definition to state that the extended ballistic coefficient is that value which yields a correct prediction of time-of-flight measured over a much longer range.

Extending the definition of ballistic coefficient in this way changes the function of legacy procedures from the extrapolation of short range data to the interpolation of long range data. The legacy procedure is forced to fit experimental data at long range to determine the extended ballistic coefficient. The legacy procedure is then used with the extended ballistic coefficient to interpolate the behavior at intermediate ranges. Customary use of the legacy procedure uses short-range measurements to extrapolate long range behavior. If the time-of-flight is measured over a short range, say 300 yards or less, then the extended ballistic coefficient converges back to the customary value. The Model 43 system was designed to operate in this region. At this time the universal applicability of the G1 drag function was accepted as “settled science”.

The extended procedure provides for prediction of behavior at a continuum of ranges from gun the maximum test range. The procedure requires increasing the test range for each step instead of simply testing over additional but separate shorter ranges. This assures forced fit of prediction to reality at multiple ranges.

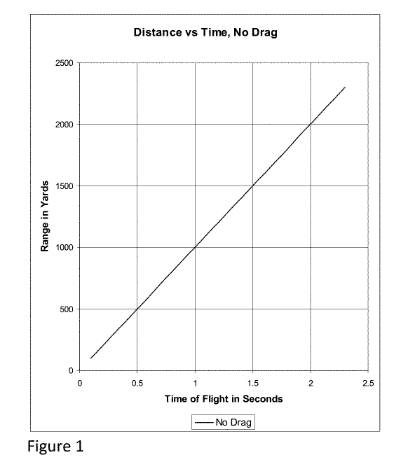

Now consider the relationship between time and distance. FIG. 1 shows the elementary relationship between distance and time. If we start at 3000 feet per second and have no air drag, we reach 1000 yards in exactly 1 second. The relationship between time and distance is simple and constant. We have a straight line. Add air drag to the problem. At each instant in time the bullet slows an amount dictated by its velocity at the time and the assumed drag function. An extremely high ballistic coefficient coupled with thin air may get close to the straight-line plot, but we still must contend with the air drag.

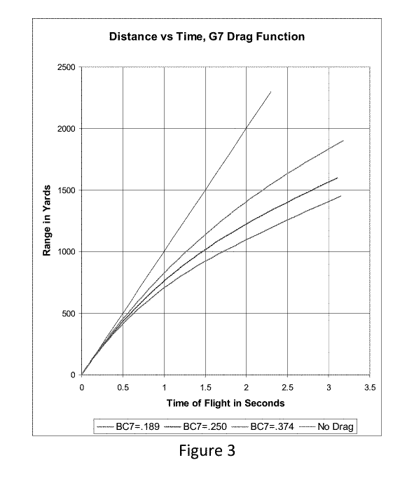

Here are the distance-versus-time curves for three bullets. All have a muzzle velocity of 3000 feet per second. The thin black line at the top shows no air drag. The lower curves are those predicted using the common G1 drag function with ballistic coefficients of 0.750, 0.500 and 0.375. The green curve from the 0.750 BC is closest to the straight line, and the curves get progressively farther from the line as the BC diminishes. There is much discussion of G1 versus G7. G1 is customary and G7 is advocated as being a notch closer to perfection. You expect to see a difference. FIG. 3 shows similar curves using G7 predictions instead of G1 predictions.

The curves for G1 and G7 appear practically identical to 800 yards. We have shown only three curves of each drag function family, each corresponding to a unique ballistic coefficient. Within each family are thousands of curves corresponding to different initial velocities and ballistic coefficients.

How do we choose a curve that accurately predicts the behavior of our bullet fired from our gun? Time-of-flight is most important, but we must place our distant target at a specific place or range. Because we are confident shooting to maximum ranges where the bullet remains supersonic, we place our target to include that maximum range. It is often practical to set our target near the range where we expect the remaining velocity to be near Mach 1.2 or 1350 fps.

With no air drag, our sample bullet starting at 3000 fps takes exactly 1 second to travel 1000 yards. Assume that the air drag slows the bullet so that it actually takes 1.500 seconds to travel 1000 yards. That gives a data point on our picture of distance-versus-time. If we look at curves from the G1 drag function including a muzzle velocity of 3000 fps, we find that one curve with an extended ballistic coefficient C1=0.471 passes through the downrange data point where the time is 1.500 seconds at the range of 1000 yards. Eureka! We've found a predicted curve that exactly fits the bullets behavior at the long range.

Using the same muzzle velocity and time-of-flight, we find a curve from the G7 family with ballistic coefficient C7=0.238 also passes through the downrange point. We anticipate trouble because we have two solutions for the same problem. Which solution should is correct? Plot both curves.

The blue BC1 line remains perfectly hidden behind the red BC7 line out well past 1000 yards or 1.5 seconds. It makes no practical difference if you choose to use G1 or G7 out to 1000 yards if you have accurately trued at 1000 yards. If you first measure both muzzle velocity and the time-of-flight, then your prediction is trued when you determine the ballistic coefficient that causes the curve to pass through the long-range true point. Comparing the G1 and G7 based predictions for drop and wind, you will find that they agree within 0.05 mils out to 1000 yards.

There are slight differences beyond 1000 yards. For many years, Sierra and others have provided ballistic coefficient values “stepped” as a function of velocity. At some velocities the measured drag of the bullet differs from the drag predicted by the G1 function and the ballistic coefficient is adjusted in steps to reflect this misfit. This procedure is well proven. Sierra's stepped ballistic coefficients are typically provided only for supersonic velocities where variations in ballistic coefficient are relatively small. Tests indicate that the stepped procedure remains applicable over longer distances when the steps are properly chosen.

We have shown how to determine an extended ballistic coefficient for accurate predictions down to Mach 1.2 using the legacy ballistic procedures but substituting an extended ballistic coefficient. To include ranges where the bullet becomes subsonic, fire a second test at a range where the bullet has dropped well subsonic. Using a ballistics program allowing for stepped ballistic coefficients, enter the extended ballistic coefficient for the first range. Enter the observed target velocity (computed from muzzle velocity, distance and time-of-flight from your first test) as the lower limit of the range. Adjust the extended ballistic coefficient of the next step until the total predicted time-of-flight matches the observed time-of-flight. This gives a set of two extended ballistic coefficients meeting the requirement of passing through both the experimental points of the distance versus time curve. These stepped ballistic coefficients may look rough, but they yield accurate (typically within 0.1 mil) predictions of drop and windage at ranges from muzzle to the subsonic target point.

Let's continue looking at our curves. If we assume that the bullet fired actually behaved like a G7 bullet, then it would have a time-of-flight of 2.57823 seconds at 1400 yards and its extended C7 ballistic coefficient would remain BC7=0.238. If we choose to work using G1, we must adjust the extended G1 ballistic coefficient to BC1=0.331 at velocities below 1350 fps.

After adding the stepped change in the extended G1 ballistic coefficient, the blue G1 curve is obscured by the red G7 curve out to approximately 1500 yards. If you want your predictions to reliably extend to even longer ranges, then you must test at longer ranges and add the additional trued steps to your ballistic coefficients.

This procedure is automated in the Extended Range Truing program included with the Oehler System 88. The Extended Range Truing program requires inputs of initial velocity, distance to target, time-of-flight, and atmospheric conditions. The Oehler System 88 measures the initial velocities and times-of-flight, and includes provision to record the other parameters. The program output suggests extended ballistic coefficients for up to five velocity ranges and includes the values of the step points. The user can select the drag function to be used. (Remaining velocities must have been estimated prior to tests and targets placed as convenient to fit the estimates. Estimates need only be reasonable, but the actual test range must be recorded precisely.) As inputs to the Extended Range Truing program, we suggest using the mean values for muzzle velocity and time-of-flight obtained during tests of a bullet. For indication of stability in the transonic region, we suggest examination of the extended ballistic coefficients indicated for each bullet at the transonic step. Large variations may indicate instabilities.

What has been demonstrated is a greatly improved version of “truing” where the prediction procedure is forced to match actual long-range results. You cannot predict drag functions or ballistic coefficients from published data any more than you can predict muzzle velocity from factory specs or reloading books. They will all vary from rifle to rifle, and you must true with your gun and your ammo. Application of this procedure forces your predictions to match your results at long range and at all instrumented intermediate points. This procedure eliminates uncertainties due to visual drop estimations, wind induced errors, hold errors, and the use of too-few shots.

This procedure can use any reasonable drag function. If you are comfortable with G1, and your computer handles stepped G1 ballistic coefficients, then you can use G1 with no significant loss in accuracy. If your computer handles custom drag functions or radar drag functions, use the procedure with your favored drag function. Adjust or “true” your extended ballistic coefficient so that your predictions match measured long-range times-of-flight. (In the case of Hornady's 4DOF program, adjust the axial form factor to provide a match between observed and predicted time-of-flight at the maximum range.)

The output parameters are not unique. They form an excellent approximation on which to base predictions. You may obtain different ballistic coefficients and velocity ranges depending on exact range to test target and desired drag function.

Things get difficult in ballistics when you must relate time to distance. By shooting and actually measuring time-of-flight to a distant range, you have measured “truth” at one or more points. By adjusting your prediction method until your prediction matches reality, you have trued the relationship and found the extended ballistic coefficient. It is important to note that there may be multiple points of truth along the distance versus time curve. The method outlined forces the predictions to match reality at all of the measured points. The number of test points can be increased to provide the required accuracy.

1. (canceled)

2. A method of ballistic measurement comprising:
providing a velocity measuring instrument;
positioning the velocity measuring instrument proximate a firearm operable to propel a projectile;
providing a flight duration sensor system;
providing a controller operably connected to the velocity measuring instrument and to the flight duration sensor system;
propelling a projectile having an estimated ballistic characteristic value;
operating the velocity measuring instrument to determine a measured velocity of the projectile;
operating the flight duration sensor system to determine a measured time of flight between a first position and a second position;
operating the controller based on the estimated ballistic characteristic value and the measured velocity to calculate an estimated time of flight;
operating the controller to calculate an adjustment function of the measured the time of flight and the estimated time of flight; and
operating the controller based on the function and the estimated ballistic characteristic value to determine a calculated ballistic characteristic value.

3. The method of claim 2 wherein the ballistic characteristic value is a ballistic coefficient.

4. The method of claim 2 wherein the flight duration sensor system generates a time signal that is a global positioning satellite signal.

5. The method of claim 2 further including the step of based on the calculated ballistic characteristic value, predicting the flight characteristics of a second projectile.
